(19) United States
(12) Patent Application Publication
(10) Pub. No.: US 2009/0155385 A1
(43) Pub. Date: Jun. 18, 2009

(54) METHODS OF REDUCING OR ELIMINATING SALMONELLA IN REPTILES AND/OR THEIR EGGS

(76) Inventors: Joe D. Sauer, Baton Rouge, LA (US); George W. Cook, Jr., Baton Rouge, LA (US); Christopher J. Nalepa, Zachary, LA (US)

Correspondence Address: ALBEMARLE CORPORATION;PATENT DEPARTMENT, 451 FLORIDA STREET, BATON ROUGE, LA, 70801, US

(21) Appl. No.: 12/297,296

(22) PCT Filed: Jun. 15, 2007
(86) PCT No.: PCT/US07/71348

§ 371 Date: Oct. 15, 2008

Related U.S. Application Data
(60) Provisional application No. 60/814,650, filed on Jun. 16, 2006.

(51) Int. Cl. A01N 59/08; A01N 43/50; A01N 59/00

(52) U.S. Cl. 424/665; 514/389; 424/600

(57) ABSTRACT

A method for reducing or eliminating Salmonella in reptiles and/or reptile eggs through the use of at least one N,N-dihalo-5,5-dialkylhydantoin in which each of the alkyl groups is independently selected from those containing in the range of from 1 to about 6 carbon atoms.

### FIELD OF THE INVENTION

The present invention relates to methods for reducing or eliminating Salmonella in reptiles and/or reptile eggs. More particularly, the present invention relates to methods that utilizes N,N-dihalo-5,5-dialkylhydantoin in which each of the alkyl groups is independently selected from alkyl groups containing in the range of from 1 to about 6 carbon atoms in reducing or eliminating Salmonella in reptiles and/or reptile eggs.

### BACKGROUND OF THE INVENTION

It is well recognized that reptiles are typically asymptomatic carriers of Salmonella, which is often present within the intestine, e.g., small intestine, colon, caecum, and/or fecal matter of the reptiles. The spread of Salmonella from reptile carriers presents a substantial health hazard to animals and to humans, and thus, the United States Food and Drug Administration (“FDA”) in 1974 banned the domestic sale of turtle hatchlings.

However, the ban by the FDA has not hampered the export of these turtles for sale as pets, etc. in foreign markets such as those in Europe and Asia. In fact, this export has created a thriving business in Louisiana. Currently, the Louisiana turtle farming industry is made up of 56 licensed commercial turtle farms, which are required to register and obtain a license from the Louisiana Department of Agriculture. The Louisiana turtle farming industry represents greater than 90% of turtle hatchlings exported from the Untied States for sale in the pet market.

Even with a thriving export business, the domestic sale of turtles is still desired. In an effort to open the domestic market, the Salmonella problem in turtles was, and currently still is, extensively studied, which led to the discovery that the turtle eggs are a major means by which the Salmonella is spread to young turtles. Thus, for the past 20 or so years the antibiotic gentamicin sulfate has been used in an attempt to eradicate Salmonella from turtle eggs by treating sanitized eggs in gentamicin sulfate baths while under vacuum. However, statutes and regulations such as those in Louisiana require that turtle eggs be treated, and the resultant hatchling certified, Salmonella free, by FDA approved laboratories, before animals enter commerce, and the gentamicin sulfate sanitation process can not provide these assurances.

Thus, many additional treatments have been proposed to eliminate or reduce the growth of Salmonella in turtles. Some of the treatments proposed involved the use of antibiotics, which in itself creates problems. For example, children handling the turtles could be at risk if the bacteria become resistant to the antibiotic used in treating the turtle eggs, etc. Still others have proposed feeding probiotics to reptiles in an attempt to eliminate or reduce the growth of Salmonella in them. For example, see U.S. Pat. No. 5,879,719.

However, none of these treatments have been effective at overturning the domestic ban on the sale of turtles, and the turtle farming industry is still seeking to overturn this ban and regain the potentially lucrative domestic pet market. The FDA has stated that to do so the industry must present data that shows a non-antibiotic, antimicrobial agent can be used in place of gentamicin sulfate—the primary objective, because gentamicin-resistant bacteria can emerge in the product. Further, the FDA added additional concerns they feel must be addressed before the ban can be overturned; 1) provide assurance that the turtle does not become “reinfected” in the home environment, and 2) provide proof that bacteria do not become resistant to antimicrobial agents which are used to treat eggs.

Thus, there exists a need for a non-antibiotic method of reducing or eliminating Salmonella in reptiles and/or reptile eggs.

### SUMMARY OF THE INVENTION

The present invention relates to methods of reducing or eliminating Salmonella in reptile eggs comprising contacting one or more reptile eggs with an aqueous microbiocidal solution containing at least one N,N-dihalo-5,5-dialkylhydantoin in which each of the alkyl groups is independently selected from alkyl groups containing in the range of from 1 to about 6 carbon atoms.

The present invention also relates to methods of reducing or eliminating Salmonella in reptiles comprising contacting one or more reptiles with an aqueous microbiocidal solution containing at least one N,N-dihalo-5,5-dialkylhydantoin in which each of the alkyl groups is independently selected from alkyl groups containing in the range of from 1 to about 6 carbon atoms.

The present invention also relates to methods of reducing or eliminating Salmonella in reptiles comprising administering to one or more reptiles i) at least one N,N-dihalo-5,5-dialkylhydantoin in which each of the alkyl groups is independently selected from alkyl groups containing in the range of from 1 to about 6 carbon atoms, or (ii) an aqueous microbiocidal solution containing at least one N,N-dihalo-5,5-dialkylhydantoin in which each of the alkyl groups is independently selected from alkyl groups containing in the range of from 1 to about 6 carbon atoms, or (iii) both (i) and (ii).

The present invention also relates to methods of reducing or eliminating Salmonella in reptiles comprising contacting, one or more times, one or more reptiles with a) a sodium hypochlorite solution and b) i) at least one N,N-dihalo-5,5-dialkylhydantoin in which each of the alkyl groups is independently selected from alkyl groups containing in the range of from 1 to about 6 carbon atoms, or (ii) an aqueous microbiocidal solution containing at least one N,N-dihalo-5,5-dialkylhydantoin in which each of the alkyl groups is independently selected from alkly groups containing in the range of from 1 to about 6 carbon atoms, or (iii) both (i) and (ii), and a) and b) can be conducted in any order.

The present invention also relates to methods of reducing or eliminating Salmonella from reptile eggs comprising contacting, one or more times, one or more reptile eggs with a) a sodium hypochlorite solution and b) i) at least one N,N-dihalo-5,5-dialkylhydantoin in which each of the alkyl groups is independently selected from alkyl groups containing in the range of from 1 to about 6 carbon atoms, or (ii) an aqueous microbiocidal solution containing at least one N,N-dihalo-5,5-dialkylhydantoin in which each of the alkyl groups is independently selected from alkly groups containing in the range of from 1 to about 6 carbon atoms, or (iii) both (i) and (ii), and a) and b) can be conducted in any order.

### DETAILED DESCRIPTION OF THE INVENTION

The use of N,N-dihalo-5,5-dialkylhydantoins in the control of Salmonella in the processing of chickens is well-known. For example see, U.S. Pat. Nos. 6,908,636 and 6,919,364; U.S. patent application Ser. Nos. 10/313,243, 10/313,245, 11/103,703, 11/180,054, 10/603,132, and 10/603,130; and PCT Application Numbers US04/14762, US04/43732, and US04/43381. However, heretofore, it has never been proposed to use N,N-dihalo-5,5-dialkylhydantoins in the control of Salmonella in reptiles and/or their eggs. The inventors hereof have unexpectedly discovered that the use of N,N-dihalo-5,5-dialkylhydantoins and/or aqueous solutions containing the same, can be used to control, or substantially eliminate, Salmonella in reptiles and/or reptile eggs.

Non-limiting examples of reptiles suitable for treatment by the present invention include turtles, crocodilians, lizards, snakes and tuatara. Non-limiting examples of reptile eggs suitable for treatment by the present invention include those from turtles, crocodilians, lizards, snakes and tuatara. The reptile treated by the methods of the present invention can be a turtle, and the reptile eggs treated by the present method are thus turtle eggs.

In the practice of the present invention one or more reptiles and/or one or more reptile eggs are contacted with an aqueous solution containing at least one N,N-dihalo-5,5-dialkylhydantoins, thus, N,N-dihalo-5,5-dialkylhydantoins used can be water soluble. N,N-dihalo-5,5-dialkylhydantoins suitable for use are those in which the alkyl groups, independently, each contain from 1 to about 6, or in the range of from 1 to 4, carbon atoms. The N,N-dihalo-5,5-dialkylhydantoins can be those in which both of the halogen atoms are selected from bromine, or the N,N-dihalo-5,5-dialkylhydantoins can be those in which one of the halogen atoms is chlorine and the other is bromine or chlorine. Suitable compounds of this type include, for example, such compounds as 1,3-dibromo-5,5-dimethylhydantoin, 1,3-dichloro-5,5-dimethylhydantoin, 1,3-dichloro-5,5-diethylhydantoin, 1,3-dichloro-5,5-di-n-butylhydantoin, 1,3-dichloro-5-ethyl-5-methylhydantoin, N,N′-bromochloro-5,5-dimethylhydantoin, N,N′-bromochloro-5-ethyl-5-methylhydantoin, N,N′-bromochloro-5-propyl-5-methylhydantoin, N,N′-bromochloro-5-isopropyl-5-methylhydantoin, N,N′-bromochloro-5-butyl-5-methylhydantoin, N,N′-bromochloro-5-isobutyl-5-methylhydantoin, N,N′-bromochloro-5-sec-butyl-5-methylhydantoin, N,N′-bromochloro-5-tert-butyl-5-methylhydantoin, N,N′-bromochloro-5,5-diethylhydantoin, and mixtures of any two or more of the foregoing. N,N′-bromochloro-5,5-dimethylhydantoin is available commercially under the trade designation BROMICIDE biocide, available from Chemtura Corporation. Another suitable bromochlorohydantoin mixture is composed predominantly of N,N′-bromochloro-5,5-dimethylhydantoin together with a minor proportion by weight of 1,3-dichloro-5-ethyl-5-methylhydantoin. A mixture of this latter type is available in the marketplace under the trade designation DANTOBROM biocide, available from the Lonza Corporation.

It should be noted that when a mixture of two or more of the foregoing N,N′-bromochloro-5,5-dialkylhydantoins is used in the practice of the present invention, the individual N,N-dihalo-5,5-dialkylhydantoins of the mixture can be in any proportions relative to each other. It will also be understood that the designation N,N′ in reference to, for example, N,N′-bromochloro-5,5-dimethylhydantoin means that this compound can be (1) 1-bromo-3-chloro-5,5-dimethylhydantoin, or (2) 1-chloro-3-bromo-5,5-dimethylhydantoin, or (3) a mixture of 1-bromo-3-chloro-5,5-dimethylhydantoin and 1-chloro-3-bromo-5,5-dimethylhydantoin. Also, it is conceivable that some 1,3-dichloro-5,5-dimethylhydantoin and 1,3-dibromo-5,5-dimethylhydantoin could be present in admixture with (1), (2) or (3).

If the at least one, in some cases only one, N,N-dihalo-5,5-dialkylhydantoin used in the practice of the present invention is a dibromo N,N-dihalo-5,5-dialkylhydantoin, the N,N-dibromo-5,5-dialkylhydantoin is 1,3-dibromo-5,5-dialkylhydantoin in which one of the alkyl groups is a methyl group and the other alkyl group contains in the range of 1 to about 6, or in the range of from 1 to 4, carbon atoms. Thus, N,N-dibromo-5,5-dialkylhydantoins can comprise 1,3-dibromo-5,5-dimethylhydantoin, 1,3-dibromo-5-ethyl-5-methylhydantoin, 1,3-dibromo-5-n-propyl-5-methylhydantoin, 1,3-dibromo-5-isopropyl-5-methylhydantoin, 1,3-dibromo-5-n-butyl-5-methylhydantoin, 1,3-dibromo-5-isobutyl-5-methylhydantoin, 1,3-dibromo-1-sec-butyl-1-methylhydantoin, 1,3-dibromo-5-tert-butyl-5-methylhydantoin, and mixtures of any two or more of them. Of these N,N-dibromo-5,5-dialkylhydantoins, 1,3-dibromo-5-isobutyl-5-methylhydantoin, 1,3-dibromo-5-ethyl-5-methylhydantoin, and 1,3-dibromo-5-n-propyl-5-methylhydantoin are most cost effective. Of the mixtures of the foregoing N,N-dibromo-5,5-dialkylhydantoins that can be used pursuant to this invention, 1,3-dibromo-5,5-dimethylhydantoin can be used as one of the components, e.g., as a mixture of 1,3-dibromo-5,5-dimethylhydantoin and 1,3-dibromo-5-ethyl-5-methylhydantoin. In this invention, at least one of the N,N-dihalo-5,5-dialkylhydantoins can be a mixture of at least 1,3-dibromo-5,5-dimethylhydantoin in combination with at least one other N,N-dihalo-5,5-dialkylhydantoin, e.g., 1,3-dibromo-5-ethyl-5-methylhydantoin.

The at least one, in some cases only one, N,N-dihalo-5,5-dialkylhydantoin used herein can be water-soluble 1,3-dibromo-5,5-dialkylhydantoins in which one of the alkyl groups is a methyl group and the other is an alkyl group containing from 1 to about 6, or in the range of from 1 to 4, carbon atoms, e.g., 1,3-dibromo-5,5-dimethylhydantoin. This compound is available in the marketplace in tablet or granular form under the trade designations ALBROM 100T biocide and ALBROM 100PC biocide, both available commercially from the Albemarle Corporation.

It should be noted that when a mixture of two or more of the foregoing 1,3-dibromo-5,5-dialkylhydantoins is used in the practice of the present invention, the individual N,N-dibromo-5,5-dialkylhydantoins of the mixture can be in any proportions relative to each other.

In the practice of the present invention the at least one, sometimes only one, N,N-dihalo-5,5-dialkylhydantoin above are solubilized in an aqueous medium to form an aqueous microbicidal solution. The aqueous medium can be water, or a suitable innocuous, harmless, water-soluble organic solvent, such as acetonitrile, with or without water. If water-soluble organic solvents are used, the reptiles and/or reptile eggs can be washed with clean water, after being contacted with the aqueous microbicidal solution, to remove residues from such solvent.

The aqueous microbicidal solution used in the practice of the present invention can be formed by combining, mixing, etc., the components of the aqueous microbicidal solution in any order and by any method known, and the order in which they are combined is not critical to the instant invention and any method that can achieve substantially complete solubilization of the at least one N,N-dihalo-5,5-dialkylhydantoin in the aqueous medium can be used. For example, the aqueous microbiocidal solutions used pursuant to the present invention can be formed in many cases by adding the at least one N,N-dihalo-5,5-dialkylhydantoin itself (i.e., in undiluted form) to water A concentrated solution containing the at least one N,N-dihalo-5,5-dialkylhydantoin and water can be formed, and then, when the aqueous microbiocidal solution is needed, additional water added to the concentrated solution to form an aqueous microbiocidal solution. If a water-soluble organic solvent is used in the preparation of the aqueous microbiocidal solutions, the at least one N,N-dihalo-5,5-dialkylhydantoin can be solubilized directly into the organic solvent. If a combination of organic solvent and water is used, the at least one N,N-dihalo-5,5-dialkylhydantoin can be solubilized in the water and then the organic solvent introduced, the at least one N,N-dihalo-5,5-dialkylhydantoin first solubilized in the organic solvent and then the water introduced, the at least one N,N-dihalo-5,5-dialkylhydantoin solubilized in a pre-formed mixture of the organic solvent, etc.

The concentration of the at least one N,N-dihalo-5,5-dialkylhydantoin in the aqueous microbiocide solution will vary depending on various factors such as the particular N,N-dihalo-5,5-dialkylhydantoin(s) being used, the nature and frequency of prior microbiocidal treatments, the types and nature of the Salmonella present, the amount and types of nutrients available to the Salmonella, the nature and extent of cleansing actions, if any, taken in conjunction with the microbiocidal treatment, the surface or locus of the Salmonella being treated, and so on. In any event, a microbiocidally-effective amount of the aqueous microbiocide solution will be applied to or contacted with the reptile and/or reptile eggs.

Typically the aqueous microbiocide solution will contain a microbiocidally-effective amount of the at least one, sometimes only one, N,N-dihalo-5,5-dialkylhydantoin, which means that the aqueous microbiocide solution will typically have an active halogen concentration in the range of about 2 to about 1000 ppm (wt/wt), or in the range of about 2 to about 500 ppm (wt/wt), or in the range of about 25 to about 250 ppm (wt/wt), active halogen being determinable by use of the conventional DPD test procedure, which is described in U.S. Pat. No. 6,908,636. If the actual active halogen in the solution consists of active chlorine, the concentration of the diluted solution used can be at least two to three times higher than the minimums of the foregoing ranges. In the case of the 1,3-dibromo-5,5-dialkylhydantoins used pursuant to this invention, a particularly useful range for use in ordinary situations is in the range of about 50 to about 150 ppm (wt/wt) of active bromine. When contacting reptiles and/or reptile eggs with aqueous solutions formed from at least one 1,3-dibromo-5,5-dialkylhydantoin, it is useful to use a solution containing a microbiocidally effective amount of active bromine that does not significantly or appreciably bleach the “skin” of the reptile eggs or the skin or shell of the reptile. Such amount is typically within the range of about 0.5 to about 30 ppm (wt/wt) or in the range of about 5 to about 25 ppm (wt/wt) of active bromine as determinable by the DPD test procedure. It will be understood that departures from the foregoing ranges can be made whenever deemed necessary or desirable, and such departures are within the spirit and scope of the present invention. Consequently, depending upon the particular application of the aqueous microbiocide solution, the concentration of N,N-dihalo-5,5-dialkylhydantoin in the aqueous microbiocide solution can extend from as little as about 2 ppm N,N-dihalo-5,5-dialkylhydantoin up to as high as the maximum water solubility of the particular N,N-dihalo-5,5-dialkylhydantoin being used, at the temperature at which such aqueous microbiocide solution is being used.

It should be noted that although the above halogen concentrations are being measured according to the DPD method, there are two different types of procedures that can be used for determining active halogen content, whether active chlorine, active bromine or both. For measuring concentrations in the vicinity of above about 500 ppm or so (wt/wt) of active bromine or above about 1100 ppm of active chlorine, starch-iodine titration is a useful procedure, which method is described in U.S. Pat. No. 6,908,636. On the other hand, where concentrations are below levels in these vicinities, the conventional DPD test procedure is more suitable, as this test is designed for measuring very low active halogen concentrations, e.g., active chlorine concentrations in the range of from zero to about 11-12 ppm (wt/wt) or active bromine concentrations in the range of from zero to about 5 ppm (wt/wt). In fact, where the actual concentration of active chlorine is between about 1′-12 ppm and about 1100 ppm (wt/wt), or the where the actual concentration of active bromine is between about 5 ppm and about 100 ppm (wt/wt), the test sample is typically diluted with pure water to reduce the actual concentration to be in the range of about 4 to about 11-12 ppm in the case of active chlorine and to be in the range of about 2 to about 5 ppm in the case of active bromine before making the DPD analysis. It can be seen therefore that while there is no critical hard-and-fast concentration dividing line between which procedure to use, the approximate values given above represent a practical approximate dividing line, since the amounts of water dilution of more concentrated solutions when using the DPD test procedure increase with increasing initial active halogen concentration, and such large dilutions can readily be avoided by use of starch-iodine titration when analyzing the more concentrated solutions. In short, with suitably dilute solutions use of the DPD test procedure is recommended, and with more concentrated solutions use of starch-iodine titration is recommended.

The reptiles and/or the reptile eggs can be contacted with the aqueous microbicide solution by any means known in the art. Non-limiting examples of suitable means include wiping the reptile and/or reptile eggs with a towel that the aqueous microbicide solution has been applied to, dipping the reptile and/or reptile eggs in the aqueous microbicide solution, spraying the aqueous microbicide solution onto the reptile and/or reptile eggs, etc. The reptile eggs can be submerged in the aqueous microbicide solution.

The reptile and/or reptiles eggs can be first contacted one or more times with a sodium hypochlorite solution prior to contacting with the aqueous microbicide solution. The concentration of the sodium hypochlorite in the solution is readily selected by one having ordinary skill in the art because sodium hypochlorite solutions such as these are commonly used in treating Salmonella in reptile eggs.

The present invention relates to a method of administering to one or more reptiles (i) at least one N,N-dihalo-5,5-dialkylhydantoin in which each of the alkyl groups is independently selected from alkyl groups containing in the range of from 1 to about 6, or in the range of from 1 to 4, carbon atoms, or (ii) an aqueous microbiocidal solution containing at least one N,N-dihalo-5,5-dialkylhydantoin in which each of the alkyl groups is independently selected from alkly groups containing in the range of from 1 to about 6, or in the range of from 1 to 4, carbon atoms, or (iii) both (i) and (ii). The administration of (i), (ii), or (iii) to the reptile is to substantially control, inhibit or eliminate Salmonella colonization or infestation in the treated reptile in comparison to the untreated reptile. An aqueous microbiocidal solution can be administered to the reptile.

Typical amounts of aqueous microbiocidal solution effective to control, inhibit, reduce and/or eliminate Salmonella may vary, for example, based on the type of reptile, the weight and/or the age of the reptile, etc. However, for example, from about one-tenth to about ten teaspoonfuls of the aqueous microbiocidal solution may be administered to the reptile per day.

The aqueous microbiocidal solution can be administered to the reptile in one or more doses via forced feeding, or any other means capable of introduction into the digestive system, stomach, and/or intestinal tract of the reptile. The N,N-dihalo-5,5-dialkylhydantoin can be mixed in with the reptiles normal food or water or the aqueous microbiocidal solution applied to the reptile's food. The dosage to be delivered to a given reptile may vary from about 10 weight % to about 50 weight %, based on the total weight of the aqueous microbiocidal solution plus the food administered to the reptile.

Methods of this invention have several advantages. For example, 1,3-dibromo-5,5-dimethyhydantoin (DBDMH) is a dry compound that is self-activated when added to water. Both bromines are released to form hypobromous acid and dimethyhydantoin (inert). Bromine is a better biocide than chlorine at higher pH (e.g., 7.5 and above). The biocide dosage is 0.5 to 2.0 ppm free bromine. Bromine has lower volatility then that of chlorine, so there is less evaporation loss. Bromine-based biocides are more effective in water containing ammonia contaminants (like proteins).

### EXAMPLE

### Experimental Background

The following experiments were carried out to demonstrate the advantages of this invention. The goal was to compare the effectiveness of killing Salmonella bacteria by egg washing with hypochlorite bleach, and, in accordance with this invention, with a particular N,N-dihalo-5,5-dialkylhydantoin, i.e., 1,3-dibromo-5,5-dimethyhydantoin (DBDMH). The experiments were carried out to determine the concentrations and time of DBDMH treatments to: (A.) effectively kill Salmonella bacteria on turtle eggs, and (B.) give acceptable turtle egg-hatching rates when contrasted to the traditionally utilized hypochlorite bleach systems.

Currently, common practice among turtle farmers is to wash turtle eggs with Clorox, a chlorine [hypochlorite] disinfectant. However, it is generally accepted in the turtle farming industry that use of hypochlorite negatively impacts turtle egg hatch rate. Whereas use of methods of this invention does not appear to negatively impact the egg hatching rates.

### Salmonella Detection Procedures

10 ml of homogenate was incubated with additional 40 mls of fresh lactose for 24 hrs at 37° C. This pre-enrichment flask was sampled by placing 1 ml into enrichment tubes: 2 tubes of 7 mls Tetrationate [TT] broth and 2 tubes 7 mls of Selenite Cysteine [SC] broth. SC was incubated for 24 hrs and TT was incubated for 48 hrs, then loopfuls were streaked onto selective agar media for Salmonella identification, bismuth sulfite and XLT4, respectively. In addition, two 1 ml samples of these enrichment broths were pelleted in eppendorf tubes. Pelleted cells were lysed and DNA was screened by PCR analysis for Salmonella's InvA gene.

### Control Study—No Disinfectant Treatment

Five turtle farms provided turtle eggs for control evaluations. Results (expressed as total bacterial counts per control egg homogenate sample) from the salmonella assays were:

| | |
|---|---|
| Farm 1: | 10⁷ |
| Farm 2: | 10⁶ |
| Farm 3: | 10⁶ |
| Farm 4: | 10⁵ |
| Farm 5: | 10⁷ |

Similar procedures were utilized in the obtaining the following data wherein various disinfectant treatments were employed. Results are expressed as total bacterial counts per control egg homogenate sample.

### Control Study—Chlorine (Hypochlorite) Disinfection Treatment

| Farm ID | Bacterial Counts | Hatch Rate |
|---|---|---|
| Farm 1: | 10⁴ | N/A (not applicable) |
| Farm 2: | 0 | N/A |
| Farm 3: | 10⁵ | N/A |
| Farm 4: | 10³ | N/A |
| Farm 5: | nd* | N/A |

(*nd = determined)

### Control Study—Chlorine (Hypochlorite) Disinfection Treatment Followed by 20 Minute Water Rinse

| Farm ID | Bacterial Counts | Hatch Rate |
|---|---|---|
| Farm 1: | 10³ | 48% |
| Farm 2: | 0 | 64% |
| Farm 3: | 0 | 57% |
| Farm 4: | 0 | 62% |
| Farm 5: | 10⁵ | 82% |

### DBDMH Active Study A—Bromine (DBDMH) Disinfection Treatment (100 ppm for 10 Minutes)

| Farm ID | Bacterial Counts | Hatch Rate |
|---|---|---|
| Farm 1: | 10³ | 69% |
| Farm 2: | 0 | 71% |
| Farm 3: | 0 | 57% |
| Farm 4: | 0 | 35% |
| Farm 5: | 10⁵ | 76% |

### DBDMH Active Study A—Bromine (DBDMH) Disinfection Treatment (100 ppm for 20 Minutes)

| Farm ID | Bacterial Counts | Hatch Rate |
|---|---|---|
| Farm 1: | 0 | 92% |
| Farm 2: | 10² | 58% |
| Farm 3: | 0 | 67% |
| Farm 4: | 0 | 65% |
| Farm 5: | 10⁴ | 0* |

(*eggs did not hatch due to infestation by flies)

### DBDMH Active Study A—Bromine (DBDMH) Disinfection Treatment (500 ppm for 10 Minutes)

| Farm ID | Bacterial Counts | Hatch Rate |
|---|---|---|
| Farm 1: | 0 | 54% |
| Farm 2: | 10³ | 58% |
| Farm 3: | 0 | 89% |
| Farm 4: | 0 | 54% |
| Farm 5: | 10⁴ | 65% |

### DBDMH Active Study A—Bromine (DBDMH) Disinfection Treatment (500 ppm for 20 Minutes)

| Farm ID | Bacterial Counts | Hatch Rate |
|---|---|---|
| Farm 1: | 10² | 87% |
| Farm 2: | 0 | 56% |
| Farm 3: | 0 | 63% |
| Farm 4: | 0 | 63% |
| Farm 5: | 10⁵ | 84% |

The above description is directed to several embodiments of the present invention. Those skilled in the art will recognize that other means, which are equally effective, could be devised for carrying out the spirit of this invention. It should also be noted that the present invention contemplates that all ranges discussed herein include ranges from any lower amount to any higher amount.

What is claimed:

1. A method of reducing or eliminating Salmonella in reptiles and/or reptile eggs comprising contacting one or more reptiles and/or one or more reptile eggs with an aqueous microbiocidal solution containing at least one N,N-dihalo-5,5-dialkylhydantoin in which each of the alkyl groups is independently selected from alkyl groups containing in the range of from 1 to about 6 carbon atoms.

2. The method according to claim 1 wherein said microbiocidal solution has an active halogen concentration in the range of from about 2 to about 1000 ppm (wt/wt) active halogen.

3. The method according to claim 2 wherein said reptiles are selected from turtles, crocodilians, lizards, snakes, and/or tuataras and said reptile eggs are selected from turtle, crocodilian, lizard, snake, and/or tuatara eggs.

4. The method according to claim 1 wherein said reptile eggs are turtle eggs and said reptiles are turtles.

5. The method according to claim 3 wherein said at least one N,N-dihalo-5,5-dialkylhydantoin is water soluble.

6. The method according to claim 5 wherein said at least one N,N-dihalo-5,5-dialkylhydantoin is selected from those in which one of the halogen atoms is chlorine and the other is bromine or chlorine.

7. The method according to claim 6 wherein the alkyl groups of said at least one N,N-dihalo-5,5-dialkylhydantoin, are independently selected from alkyl groups containing in the range of from 1 to 4 carbon atoms.

8. The method according to claim 6 wherein said at least one N,N-dihalo-5,5-dialkylhydantoin is selected from 1,3-dichloro-5,5-dimethylhydantoin, 1,3-dichloro-5,5-diethylhydantoin, 1,3-dichloro-5,5-di-n-butylhydantoin, 1,3-dichloro-5-ethyl-5-methylhydantoin, N,N′-bromochloro-5,5-dimethylhydantoin, N,N′-bromochloro-5-ethyl-5-methylhydantoin, N,N′-bromochloro-5-propyl-5-methylhydantoin, N,N′-bromochloro-5-isopropyl-5-methylhydantoin, N,N′-bromochloro-5-butyl-5-methylhydantoin, N,N′-bromochloro-5-isobutyl-5-methylhydantoin, N,N′-bromochloro-5-sec-butyl-5-methylhydantoin, N,N′-bromochloro-5-tert-butyl-5-methylhydantoin, N,N′-bromochloro-5,5-diethylhydantoin, 1,3-dibromo-5,5-dialkylhydantoin in which one of the alkyl groups is a methyl group and the other alkyl group contains in the range of from 1 to 6 carbon atoms, and mixtures of any two or more of the foregoing.

9. The method according to claim 5 wherein said at least one N,N-dihalo-5,5-dialkylhydantoin is 1,3-dibromo-5,5-dialkylhydantoin in which one of the alkyl groups is a methyl group and the other alkyl group contains in the range of from 1 to 6 carbon atoms.

10. The method according to claim 9 wherein said at least one N,N-dihalo-5,5-dialkylhydantoins is selected from 1,3-dibromo-5,5-dimethylhydantoin, 1,3-dibromo-5-ethyl-5-methylhydantoin, 1,3-dibromo-5-n-propyl-5-methylhydantoin, 1,3-dibromo-5-isopropyl-5-methylhydantoin, 1,3-dibromo-5-n-butyl-5-methylhydantoin, 1,3-dibromo-5-isobutyl-5-methylhydantoin, 1,3-dibromo-5-sec-butyl-5-methylhydantoin, 1,3-dibromo-5-tert-butyl-5-methylhydantoin, and mixtures of any two or more of them.

11. The method according to claim 1 wherein said microbiocidal solution has an active halogen concentration in the range of from about 25 to about 250 ppm (wt/wt) active halogen.

12. A method of reducing or eliminating Salmonella in reptiles and/or reptile eggs comprising contacting, one or more times, one or more reptiles and or one or more reptile eggs with a) a sodium hypochlorite solution and b) i) at least one N,N-dihalo-5,5-dialkylhydantoin in which each of the alkyl groups is independently selected from alkyl groups containing in the range of from 1 to about 6 carbon atoms, or (ii) an aqueous microbiocidal solution containing at least one N,N-dihalo-5,5-dialkylhydantoin in which each of the alkyl groups is independently selected from alkly groups containing in the range of from 1 to about 6 carbon atoms, or (iii) both (i) and (ii), and a) and b) can be conducted in any order.

13. The method according to claim 12 wherein said microbiocidal solution has an active halogen concentration in the range of from about 2 to about 1000 ppm (wt/wt) active halogen, as determined by the DPD test procedure.

14. The method according to claim 13 wherein said reptiles are selected from turtles, crocodilians, lizards, snakes, and/or tuataras and said reptile eggs are selected from turtle, crocodilian, lizard, snake, and/or tuatara eggs.

15. The method according to claim 13 wherein said at least one N,N-dihalo-5,5-dialkylhydantoin suitable are selected from those in which one of the halogen atoms is chlorine and the other is bromine or chlorine, or those in which both halogen atoms are bromine.

16. The method according to claim 15 wherein the alkyl groups of said at least one N,N-dihalo-5,5-dialkylhydantoin, are independently selected from alkyl groups containing in the range of from 1 to 4 carbon atoms.

17. The method according to claim 15 wherein said at least one N,N-dihalo-5,5-dialkylhydantoin is 1,3-dibromo-5,5-dialkylhydantoin in which one of the alkyl groups is a methyl group and the other alkyl group contains in the range of from 1 to 6 carbon atoms.

18. The method according to claim 17 wherein said at least one N,N-dihalo-5,5-dialkylhydantoins is a mixture of at least 1,3-dibromo-5,5-dimethylhydantoin in combination with at least one other N,N-dihalo-5,5-dialkylhydantoin.

19. The method according to claim 17 wherein said at least one N,N-dihalo-5,5-dialkylhydantoin is a mixture of 1,3-dibromo-5,5-dimethylhydantoin and 1,3-dibromo-5-ethyl-5-methylhydantoin.

20. The method according to claim 14 wherein said at least one N,N-dihalo-5,5-dialkylhydantoin is 1,3-dibromo-5,5-dimethylhydantoin.

21. The method according to claim 12 wherein said microbiocidal solution has an active halogen concentration in the range of from about 25 to about 250 ppm (wt/wt) active halogen.

22. The method according to claim 15 wherein said microbicidal solution is formed by solubilizing in an aqueous medium said at least one N,N-dihalo-5,5-dialkylhydantoin.

23. The method according to claim 22 wherein said aqueous medium is water, a water-soluble organic solvent, or mixtures thereof.

24. The method according to claim 23 wherein said aqueous medium is selected from water-soluble organic solvents and mixtures of water and water-soluble organic solvent.

25. The method according to claim 24 wherein said reptiles and/or reptile eggs are washed with clean water, after being contacted with the microbicidal solution.

26. A method of reducing or eliminating Salmonella in reptiles comprising administering to one or more reptiles i) at least one N,N-dihalo-5,5-dialkylhydantoin in which each of the alkyl groups is independently selected from alkyl groups containing in the range of from 1 to about 6 carbon atoms, or (ii) an aqueous microbiocidal solution containing at least one N,N-dihalo-5,5-dialkylhydantoin in which each of the alkyl groups is independently selected from alkly groups containing in the range of from 1 to about 6 carbon atoms, or (iii) both (i) and (ii).
